(19) United States
(12) Patent Application Publication
(10) Pub. No.: US 2003/0122840 A1
(43) Pub. Date: Jul. 3, 2003

(54) Method of optimizing video output for a computer system with digital-to-analog converter characterization data

(76) Inventors: Christopher D. Voltz, Houston, TX (US); Henry M. D'Souza, Cypress, TX (US)

Correspondence Address: AKIN, GUMP, STRAUSS, HAUER & FELD, 711 LOUISIANA STREET, SUITE 1900 SOUTH, HOUSTON, TX, 77002, US

(21) Appl. No.: 10/039,163

(22) Filed: Dec. 31, 2001

(51) Int. Cl. G09G 5/00

(52) U.S. Cl. 345/581

(57) ABSTRACT

A computer system provides a technique of optimizing video output utilizing digital-to-analog converter characterization data. A plurality of digital-to-analog converters for a plurality of color channels of a video subsystem of the computer system are driven with a set of predetermined input digital values. The resulting plurality of output analog voltages from the plurality of digital-to-analog converters are measured and then stored in a non-volatile memory as a plurality of digital characterization values. Color management software of the computer system performs color correction based on the plurality of digital characterization values.

### CROSS-REFERENCE TO RELATED APPLICATIONS

Not Applicable.

### STATEMENTS REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Field of the Invention

The present invention generally relates to video optimization for a computer system and more particularly to a method of optimizing video output for a computer system with digital-to-analog converter characterization data.

2. Description of the Related Art

A video subsystem of a computer system traditionally provides a digital-to-analog converter (DAC) for each primary color channel for interfacing to a monitor. Each DAC typically includes a voltage source that generates an analog voltage as a function of a reference voltage and an input digital value. The reference voltage is usually defined with respect to a set of resistors. When the computer is connected to the monitor, these resistors in the video subsystem typically form a resistor divider arrangement with a set of resistors in the monitor. Each resistor is typically 75 ohms. Where each resistor value is equal, the resistor divider is a one-half resistor divider. Based on the one-half resistor divider and the typical voltage range of 0-0.7 volts in the monitor, the voltage range for the voltage source of each DAC is 0-1.4 volts. Even though each DAC resides on the same chip and uses the voltage source as a common reference, each DAC does not produce the same output voltage in response to a same digital input value. As such, there is a certain percentage of variability among the DACs. Similarly, there is variability among the resistors coupled to the DACs within a certain resistor tolerance. Both forms of variability inject imprecision into the color channels of the video subsystem. This imprecision has constrained color management of the computer system.

### BRIEF SUMMARY OF THE INVENTION

Briefly, a computer system provides a technique of optimizing video output utilizing digital-to-analog converter characterization data. A plurality of digital-to-analog converters for a plurality of color channels of a video subsystem of the computer system are driven with a set of predetermined input digital values. The resulting plurality of output analog voltages from the plurality of digital-to-analog converters are measured and then stored in a non-volatile memory as a plurality of digital characterization values. Color management software of the computer system performs color correction based on the plurality of digital characterization values.

### BRIEF DESCRIPTION OF THE SEVERAL VIEWS OF THE DRAWINGS

A better understanding of the present invention can be obtained when the following detailed description of the invention is considered in conjunction with the following drawings in which:

FIG. 1 is a schematic diagram of an exemplary monitor connected to a computer system with DAC characterization data;

FIG. 2 is a diagram of an exemplary technique of acquiring DAC characterization data for storage in the computer system of FIG. 1;

FIG. 3 is a data flow diagram of an exemplary technique of measuring and storing characterization data for the DACs of FIG. 1; and

FIG. 4 is a data flow diagram of an exemplary technique of measuring and storing additional characterization data for the DACs of FIG. 1.

### DETAILED DESCRIPTION OF THE INVENTION

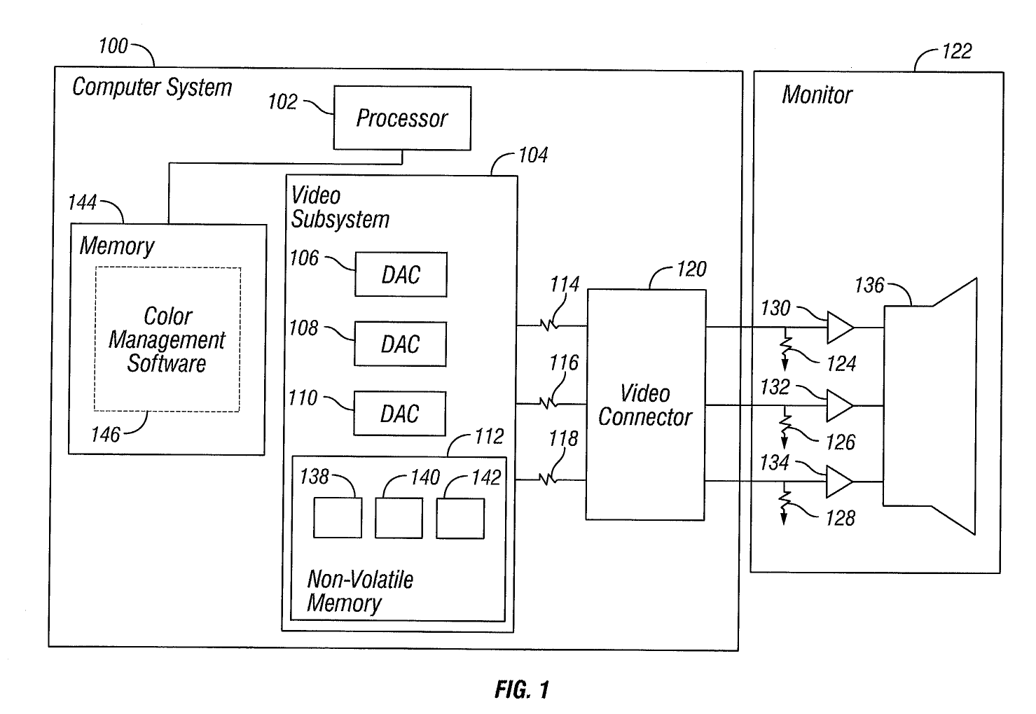

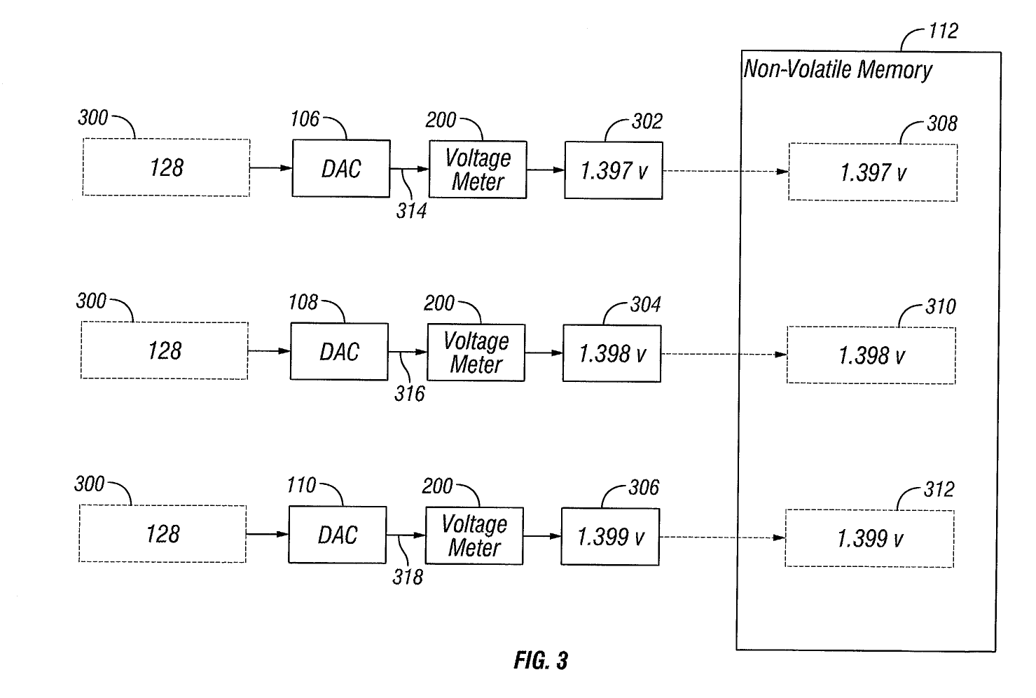

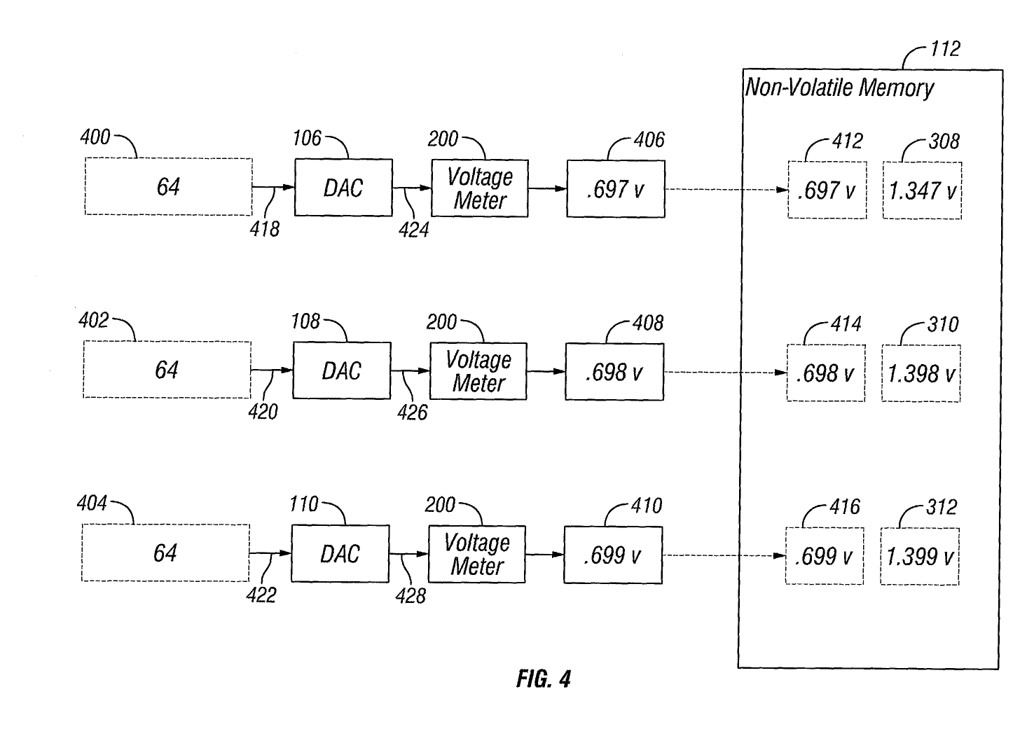

Referring to FIG. 1, an exemplary computer system 100 with DAC characterization data in relation to a cathode ray tube (CRT) monitor 122 is shown. The computer system 100 includes a processor 102 coupled to a video or graphics subsystem 104. If the computer system 100 is a high-performance system, then the video subsystem 104 may be contained in a graphics plug-in card. If the computer system 100 is a low cost system, then the video subsystem 100 may be contained in a graphics controller chip on the motherboard of the computer system 100. The video subsystem 100 includes digital-to-analog converters (DACs) 106-110 such that each primary color channel corresponds to a particular digital-to-analog converter. The DACs 106-110 may be part of a DAC interface of a graphics controller chip or card. For explanatory purposes, DAC 106 will be treated as corresponding to the “R” or red color channel; DAC 108 will be treated as corresponding to the “G” or green color channel; and DAC 110 will be treated as corresponding to the “B” or blue color channel. Each DAC 106-110 is coupled respectively to a resistor 114-118. The resistors 114-118 are coupled to a video connector 120 which directly connects to the monitor 122. The video connector 120 is typically a DB15 VGA (video graphics adapter) connector. Three pins of the connector 120 are used for the primary color channels, and another three pins of the connector 120 are used as ground signals for the primary color channels. The video subsystem 104 further includes a non-volatile memory 112 storing DAC characterization data 138-142 for the primary color channels discussed below in connection with FIGS. 3-4. The non-volatile memory 112, for example, may be an electrically erasable programmable read-only memory (EEPROM). Certain typical components of a computer system are omitted from FIG. 1 for sake of clarity.

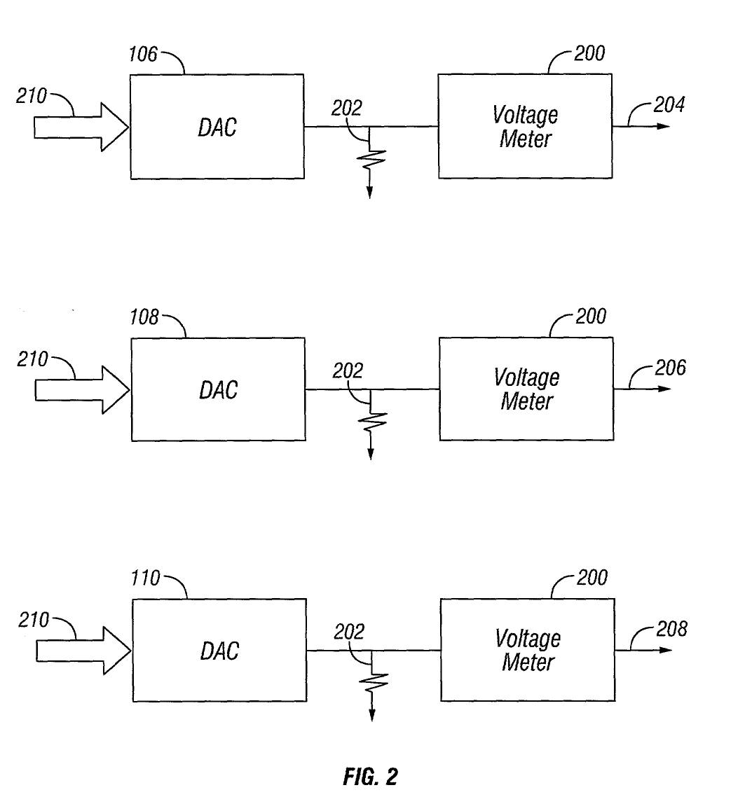

The computer system 100 further includes a memory 144 storing color management software 146 which reads the non-volatile memory 112 and performs color correction or optimization for the computer system 100 based on the DAC characterization data 138-142 in a manner that compensates for DAC variability. Color correction generally refers to rendering consistent or perceptually uniform color for images. Such color correction may involve matrix operations, filtering and/or look-up tables to map colors of the primary color channels to a standard or known color space such as sRGB. The DAC characterization data 138-142 may be included by the color management software 146 in a color profile for the video subsystem 104. The color management software 146 may be part of an operating system or alternatively may be a distinct application. In interpreting the DAC characterization data 138-142, the color management software 146 may assume linearity between the measured DAC data 138-142. In an alternative embodiment, the color management software 146 may employ a suitable non-linear mathematical model based on the measured DAC data 138-142. The measurement of the DAC characterization data 138-142 is discussed below in connection with FIGS. 2-4. Since characterization data 138-142 is stored for each DAC 106-110, the color management software 146 independently color corrects for each DAC 106-110.

The monitor 122 includes a resistor-buffer combination or termination for each primary color channel. For explanatory purposes, resistor 124 and buffer 130 will be treated as corresponding to the “R” or red color channel; resistor 126 and buffer 132 will be treated as corresponding to the “G” or green color channel; and resistor 128 and buffer 134 will be treated as corresponding to the “B” or blue color channel. Buffers 130-134 are coupled to a picture tube 136. The brightness of each primary color displayed on the picture tube 136 is a function of the input voltage to the monitor 122 corresponding to the primary color. A cathode ray tube (CRT) is one example of a picture tube 136. Alternatively, the monitor 122 may be a flat panel display.

Referring to FIG. 2, an exemplary technique of acquiring DAC characterization data for storage in the computer system 100 is shown. Each DAC 106-110 is driven with a predetermined digital input value or number 210. As an example, the value may be the maximum digital input value for each DAC 106-110. If each DAC is an 8-bit DAC, the maximum digital input value will correspond to “128” as shown in FIG. 3. The output analog voltage of each DAC 106-110 is measured with a voltage meter 200 or other digital equipment capable of measuring voltage, such as an oscilloscope, coupled to a high precision 75 ohm termination load resistor 202. A high precision resistor is generally understood to be a resistor with a highly acceptable or extremely small resistor tolerance in this particular context. Those skilled in the art will appreciate the technique for calculating an appropriate value for the precision resistor 202. The voltage meter output signals 204-206 respectively represent the output analog voltages of the DACS 106-110. The voltage meter 200 may be part of a video subsystem characterization station. Other configurations than that shown in FIG. 2 may be utilized to accomplish precision voltage measurements of the DACs 106-110. The DAC measurements may be taken on the production line in the factory of the manufacturer of the video subsystem 104, such as during the manufacturing test process, before the video subsystem 104 is supplied to the computer system manufacturer. In this way, the DAC characterization values may be pre-stored in the non-volatile memory 112 of the video subsystem 104. Alternatively, the DAC measurement could be taken in the factory of the manufacturer of the DACs 106-110. An advantage of these approaches is a lack of user intervention in characterizing the DACs 106-110.

Generally, at least two measurements per DAC 106-110 should be taken to characterize each DAC 106-110. For example, the voltage responses of each DAC 106-110 can be measured based on a minimum digital input value and a maximum digital input value. While it is widely know that DACs are not totally linear, it may be assumed that the DACs 106-110 behave linearly between two output analog voltages measured in response to the two digital input values. In that circumstance, the pair of measured output analog voltages for each DAC 106-110 represents the transfer function of the associated DAC. More particularly, if linear behavior is assumed for each DAC 106-110, the slope as defined based on the measured output analog voltages represents the transfer function of the associated DAC. If it assumed that each DAC 106-110 would result in a zero output analog voltage in response to a digital input value of zero, then a single measurement for each DAC 106-110 can be taken, rather than two measurements.

Referring to FIG. 3, an exemplary data flow for measuring and storing DAC characterization data for the DACs 106-110 is shown. The digital input value 300 for “128” is input into each DAC 106-110. If the DACs 106-110 are 8-bit DACs, then the DACs 106-110 are being driven with the maximum digital input value for the DACs 106-110. The analog signals 314-318 indicate the output analog voltages from the DACs 106-110 in response to the digital input value 300. A voltage meter 200 or other digital equipment capable of measuring voltage directly or indirectly is used to measure the analog signals 314-318. It should be understood that voltage meter readings may be taken at the same or different times for the DACs 106-110 and that multiple voltage meters may be used for the measurements as opposed to a single voltage meter. It should also be understood that diagnostic software may be used in conjunction with voltage meter 200 to record the measurements. A digital output signal 302 from the voltage meter 200 indicates a voltage of 1.397 volts for the DAC 106; a digital output signal 304 from the voltage meter 200 indicates a voltage of 1.398 volts for the DAC 108; and a digital output signal 306 from the voltage meter 200 indicates a voltage of 1.399 volts for the DAC 110. Since a voltage meter reading includes blanking intervals, the reading should be converted through calculations to the digital voltage output signals 302-306. Thus, if a voltage meter is used for the measurements, the appropriate processing should be utilized to achieve the voltage output level of each DAC 106-110. The digital data 308-312 of the output signals 302-306 is stored or recorded in the non-volatile memory 112. This information serves as characterization data for analog performance of the DACs 106-110. For example, such information indicates the variability among the DACs 106-110 in response to the same digital input value. More generally, this technique serves to characterize the color channels of the video subsystem 104 or graphics controller.

Referring to FIG. 4, an additional measurement for the DACs 106-110 is taken and stored. In this example, the digital input value 400 for “64” is input into each DAC 106-110. The analog signals 418-422 indicate the output analog voltages from the DACs 106-110 in response to the digital input value 400. Similar to FIG. 3, the voltage meter 200 is used to measure the analog signals 424-428. A digital output signal 406 from the voltage meter 200 indicates a voltage of 0.697 volts for the DAC 106; a digital output signal 408 from the voltage meter 200 indicates a voltage of 0.698 volts for the DAC 108; and a digital output signal 410 indicates a voltage of 0.699 volts for the DAC 110. The digital output signals 406-410 thus indicate a channel-to-channel mismatch of 0.001 volts between DAC 106 and DAC 108, a channel-to-channel mismatch of 0.001 volts between DAC 108 and DAC 110, and a channel-to-channel mismatch of 0.002 volts between DAC 106 and DAC 110. The digital data of the output signals 406-410 is stored in the non-volatile memory 112. The non-voltage memory 112 thereby stores data for two sets of voltage measurements for each DAC 106-110. Any number of voltage measurements may be taken for purposes of characterizing each DAC 106-110. Generally, the more voltage measurements taken for each DAC 106-110, the more precision there is injected into characterizing the variability among the DACs 106-110. For example, with more voltage measurements for each DAC 106-110, the non-linearity of the DACs 106-110 can be better taken into account.

Though a monitor is illustrated in FIG. 1, it should be understood that the disclosed techniques may be applied to a DAC interface for a television, rather than a DAC interface for a monitor. Stated another way, the voltage output level from DACs for a television such as an S-video output, rather than a VGA output for a monitor, may be characterized in accordance with the disclosed techniques. Stated yet another way, based on the disclosed techniques, any DAC of a video subsystem or graphics controller of a computer system may be characterized.

The foregoing disclosure and description of the various embodiments are illustrative and explanatory thereof, and various changes in the measurement techniques, storage techniques, color management software, DACs, components, circuit elements, circuit configurations, and signal connections, as well as in the details of the illustrated circuitry and software and construction and method of operation may be made without departing from the spirit and scope of the invention.

We claim:

1. A method of characterizing a plurality of digital-to-analog converters for a plurality of color channels of a video subsystem of a computer system, the method comprising the steps of:
driving the plurality of digital-to-analog converters with a set of predetermined input digital values;
measuring a plurality of output analog voltages of the plurality of digital-to-analog converters in response to the driving step; and
storing a plurality of digital characterization values corresponding to the plurality of output analog voltages.

2. The method of claim 1, wherein the set of predetermined input digital values comprises only a maximum input digital value for the plurality of digital-to-analog converters.

3. The method of claim 1, wherein the plurality of digital characterization values are stored in a non-volatile memory associated with the video subsystem.

4. The method of claim 1, the storing step comprising the step of:
storing a set of digital characterization values for each digital-to-analog converter of the plurality of digital-to-analog converters.

5. The method of claim 4, wherein the set of digital characterization values comprises only a single digital characterization value for each digital-to-analog converter.

6. The method of claim 1, wherein the set of predetermined input digital values comprises a plurality of input digital values for each digital-to-analog converter of the plurality of digital-to-analog converters.

7. The method of claim 1, wherein the plurality of digital characterization values comprise a plurality of digital representations of the plurality of analog output voltages.

8. The method of claim 1, wherein the plurality of digital characterization values comprise a plurality of digital values corresponding to a mathematical model for the plurality of analog output voltages.

9. The method of claim 1, wherein the measuring step is performed with a precision termination load resistor.

10. The method of claim 1, wherein the plurality of digital characterization values represents a plurality of transfer functions for the plurality of digital-to-analog converters.

11. A computer system, comprising:
a processor; and
a video subsystem coupled to the processor, the video subsystem comprising:
a plurality of digital-to-analog converters for a plurality of color channels of the video subsystem;
a video connector coupled to the plurality of digital-to-analog converters for connection to a monitor; and
a non-volatile memory storing a plurality of digital characterization values for the plurality of digital-to-analog converters.

12. The computer system of claim 11, wherein the plurality of digital characterization values represent a plurality of transfer functions for the plurality of digital-to-analog converters.

13. The computer system of claim 11, wherein the plurality of digital characterization values comprise a plurality of digital representations for a plurality of analog output voltages measured for the plurality of digital-to-analog converters by driving the plurality of digital-to-analog converters with a set of predetermined input digital values.

14. The computer system of claim 11, wherein the plurality of digital characterization values comprises only a single digital characterization value for each digital-to-analog converter of the plurality of digital-to-analog converters.

15. The computer system of claim 11, further comprising:
color management software executable by the processor to perform color correction based on the plurality of digital characterization values.

16. A video subsystem for a computer system, comprising:
a plurality of digital-to-analog converters for a plurality of color channels for the video subsystem; and
a non-volatile memory storing a plurality of digital characterization values for the plurality of digital-to-analog converters.

17. The video subsystem of claim 16, wherein the plurality of digital characterization values comprise a plurality of digital representations for a plurality of analog output voltages measured for the plurality of digital-to-analog converters by driving the plurality of digital-to-analog converters with a set of predetermined input digital values.

18. The video subsystem of claim 16, wherein the plurality of digital characterization values comprises only a single digital characterization value for each digital-to-analog converter of the plurality of digital-to-analog converters.

19. The video subsystem of claim 16, wherein the plurality of digital characterization values represent a plurality of transfer functions for the plurality of digital-to-analog converters.

20. A method of characterizing a plurality of color channels of a video subsystem of a computer system, the method comprising the steps of:
driving the plurality of color channels with a set of predetermined input digital values;
measuring a plurality of output analog signals of the plurality of color channels in response to the driving step; and
storing a plurality of digital characterization values corresponding to the plurality of output analog signals.

21. The method of claim 20, wherein the plurality of digital characterization values are stored in a non-volatile memory associated with the video subsystem.

22. The method of claim 20, wherein the video system comprises a graphics controller.
